(19) United States
(12) Patent Application Publication
(10) Pub. No.: US 2026/0276829 A1
(43) Pub. Date: Sep. 17, 2026

(54) IMAGE SENSOR AND METHOD FOR DRIVING THE SAME

(71) Applicant: TOHOKU UNIVERSITY, Sendai-shi, Miyagi (JP)

(72) Inventors: Rihito KURODA, Sendai-shi (JP); Chiachi KUO, Sendai-shi (JP)

(21) Appl. No.: 18/871,999

(22) PCT Filed: Jun. 8, 2023
(86) PCT No.: PCT/JP2023/021412

§ 371 Date: Dec. 5, 2024

(30) Foreign Application Priority Data
Jun. 8, 2022 (JP) 2022-092846

(51) Int. Cl. G01S 17/894; G01S 7/4865

(52) U.S. Cl. CPC G01S 17/894; G01S 7/4865

(57) ABSTRACT

An image sensor includes: a light reception element configured to receive incident light; a plurality of voltage signal generation units configured to acquire charge of the light reception element at a plurality of charge acquisition timings and convert the charge into a plurality of voltage signals; a pixel output unit configured to output a plurality of detected voltages based on the plurality of voltage signals; and a plurality of pixel memories configured to integrally store the plurality of detected voltages related to the plurality of charge acquisition timings in a plurality of memory cells, wherein the pixel output unit reads and outputs the detected voltages stored in the plurality of memory cells.

### CROSS-REFERENCE TO RELATED APPLICATIONS

This application is the U.S. National Stage entry of International Application No. PCT/JP2023/021412, filed on Jun. 8, 2023, which, in turn, claims priority to Japanese Patent Application No. 2022-092846, filed on Jun. 8, 2022, both of which are hereby incorporated herein by reference in their entireties for all purposes.

### TECHNICAL FIELD

The present invention relates to an image sensor and a method for driving the same.

### BACKGROUND ART

Time-of-flight (TOF) image sensors have been known. The image sensor detects a distance between the image sensor and an imaging target object, based on a time it takes for light (light source light) emitted from a light source onto the imaging target object is received by the image sensor, and outputs to the outside, a detection signal indicating the distance. Since the distance varies depending on which part of the imaging target object, having a three dimensional shape, the light is reflected, it is possible to acquire an image indicating the three dimensional shape of the imaging target object from the detection signal corresponding to each part of the imaging target object.

For example, Non-Patent Document 1 below discloses a CMOS image sensor including four charge modulators as one form of a TOF image sensor. With the four charge modulators, this CMOS image sensor is intended to achieve a high frame rate while suppressing noise.

### CITATION LIST

### Non-Patent Document

Non-Patent Document 1: M.-S. Keel et al., “7.1 A 4-tap 3.5 μm 1.2 M pixel Indirect Time-of-Flight CMOS Image Sensor with Peak Current Mitigation and Multi-User Interference Cancellation,” 2021 IEEE International Solid-State Circuits Conference (ISSCC), 2021, pp. 106 to 108, doi: 10.1109/ISSCC 42613. 2021.9365854.

### SUMMARY OF INVENTION

### Technical Problem

With the above-described background art, the frame rate can be improved up to about 60 fps. However, the improvement involves an increase in depth noise in a trade-off relationship with the frame rate, hindering further improvement in the frame rate. In order to use the TOF image sensor for various applications such as medical magnetic resonance imaging (MRI) systems, 3D scanning systems, machine vision, factory automation, and virtual reality (VR), the further improvement in the frame rate is required while suppressing the depth noise.

The present invention has been made in view of the above-described circumstances, and an object of the present invention is to provide an image sensor and a method for driving the same with which the depth noise can be suppressed from that with the known techniques, or the frame rate can be improved from that with the known techniques while suppressing the depth noise.

### Solution to Problem

For achieving the object described above, the present invention employs, as a first solution related to an image sensor, a solution represented by an image sensor including: a light reception element configured to receive incident light; a plurality of voltage signal generation units configured to acquire charge of the light reception element at a plurality of charge acquisition timings and convert the charge into a plurality of voltage signals; a pixel output unit configured to output a plurality of detected voltages based on the plurality of voltage signals; and a plurality of pixel memories configured to integrally store the plurality of detected voltages related to the plurality of charge acquisition timings in a plurality of memory cells, wherein the pixel output unit reads and outputs the detected voltages stored in the plurality of memory cells.

The present invention employs as a second solution related to the image sensor, a solution in which, in the first solution, the plurality of memory cells correspond to a plurality of storage periods including the plurality of charge acquisition timings, and each integrally store the plurality of detected voltages in a corresponding one of the storage periods.

The present invention employs as a third solution related to the image sensor, a solution in which, in the first or the second solution, the pixel output unit averages and reads the detected voltages stored in the plurality of memory cells.

The present invention employs as a fourth solution related to the image sensor, a solution in which, in the first or the second solution, the pixel output unit individually reads the detected voltages stored in the plurality of memory cells.

The present invention employs as a fifth solution related to the image sensor, a solution in which, in the first or the second solution, the pixel memories acquire the voltage signals corresponding to different phase sections in a light emission cycle of the light pulse, and store the detected voltage for each of the phase sections.

The present invention employs as a sixth solution related to the image sensor, a solution in which, in the third solution, number of the voltage signal generation units provided is four.

The present invention employs as a seventh solution related to the image sensor, a solution in which, in the fifth solution, number of the voltage signal generation units provided is two, and number of the phase sections is four.

The present invention employs as an eighth solution related to the image sensor, a solution in which, in the first or the second solution, the incident light is reflected light of light source pulsed light of a predetermined cycle.

The present invention employs, as a solution related to a method for driving an image sensor configured to receive incident light by a light reception element, acquire charge of the light reception element at a plurality of charge acquisition timings and convert the charge into a plurality of voltage signals, and output a plurality of detected voltages based on the plurality of voltage signals from a pixel, a solution represented by a method including: integrally storing the plurality of detected voltages related to the plurality of charge acquisition timings in a plurality of memory cells; and reading and outputting the detected voltages stored in the memory cells.

### Advantageous Effects of Invention

The present invention can provide an image sensor and a method for driving the same with which the depth noise can be suppressed from that with the known techniques, or the frame rate can be improved from that with the known techniques while suppressing the depth noise.

### BRIEF DESCRIPTION OF DRAWINGS

FIG. 1 A system configuration diagram illustrating an overall configuration of an image sensor A according to a first embodiment of the present invention.

FIG. 2 A circuit diagram illustrating a circuit configuration of each pixel G in the first embodiment of the present invention.

FIG. 3 A characteristic diagram illustrating a 4-tap modulation characteristic of each pixel G in the first embodiment of the present invention.

FIG. 4 A layout diagram illustrating an element layout of each pixel G in the first embodiment of the present invention.

FIG. 5 A timing chart illustrating an exposure operation of the image sensor A according to the first embodiment of the present invention.

FIG. 6A A first timing chart illustrating an output operation of the image sensor A according to the first embodiment of the present invention.

FIG. 6B A second timing chart illustrating the output operation of the image sensor A according to the first embodiment of the present invention.

FIG. 7 A characteristic table illustrating the performance of the image sensor A according to the first embodiment of the present invention.

FIG. 8 A circuit diagram illustrating a circuit configuration of each pixel Ga in a second embodiment of the present invention.

### DESCRIPTION OF EMBODIMENT

Embodiments of the present invention will be described below with reference to the accompanying drawings.

### First Embodiment

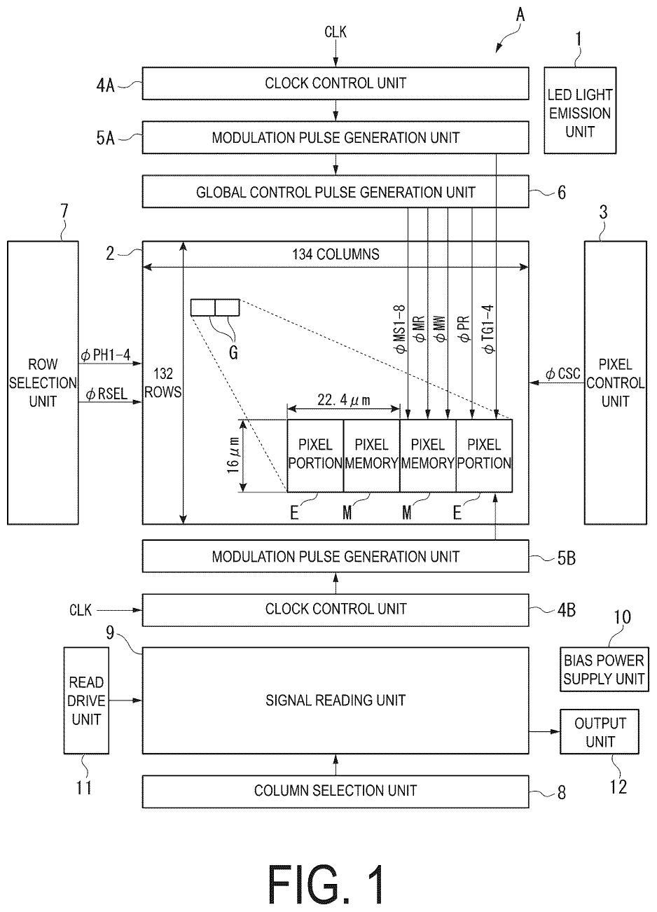

First of all, a first embodiment of the present invention will be described with reference to FIG. 1 to FIG. 7. As illustrated in FIG. 1, an image sensor A according to the first embodiment includes an LED light emission unit 1, a pixel array 2, a pixel control unit 3, clock control units 4A and 4B, modulation pulse generation units 5A and 5B, a global control pulse generation unit 6, a row selection unit 7, a column selection unit 8, a signal reading unit 9, a bias power supply unit 10, a read drive unit 11, and an output unit 12.

As will be described in detail below, the image sensor A is a so-called Time of Flight (TOF) image sensor, and is configured as a semiconductor integrated circuit (IC). The LED light emission unit 1 uses a light emitting diode (LED) as a light emitting element, and sequentially emits light source pulsed light (light source light) of a predetermined cycle in time series using the LED. Specifically, the LED light emission unit 1 intermittently emits the light source pulsed light at a predetermined light emission pulse time interval Tc onto an imaging target object.

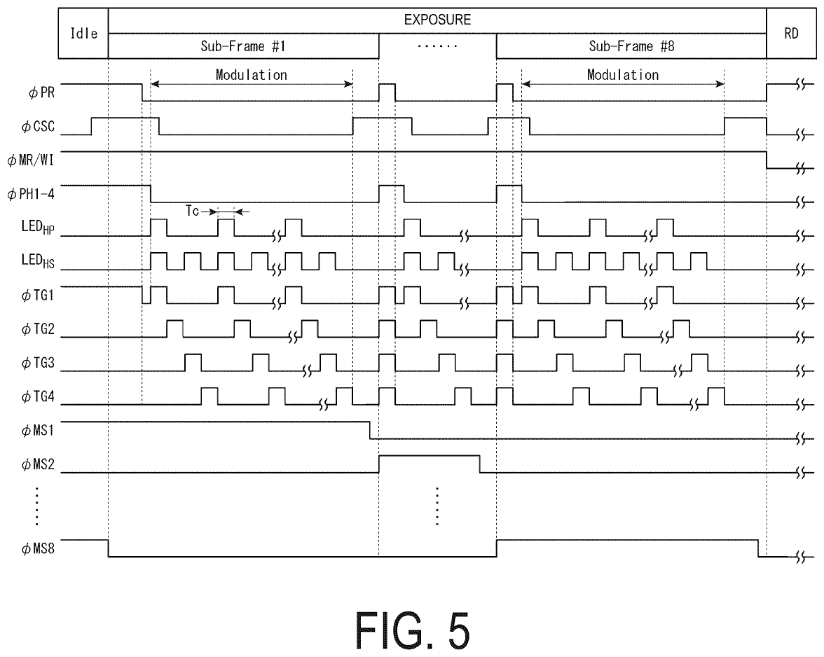

The image sensor A according to the first embodiment has a High Speed (HS) mode and an High Precision (HP) mode as operation modes. The LED light emission unit 1 emits the light source pulsed light at the light emission pulse time interval Tc individually under each of the two operation modes. As illustrated in FIG. 5, for light source pulsed light LED_{HP} under the HP mode, a duty ratio is set to 25%, the light emission pulse time interval Tc is set to 12.5 ns, and a light emission frequency is set to, for example, 20 MHz.

On the other hand, as illustrated in FIG. 5, for light source pulsed light LED_{HS} under the HS mode, the duty ratio is set to 50%, the light emission pulse time interval Tc is set to 12.5 ns, and the light emission frequency is set to 200% of that under the HP mode, that is, 40 MHz. Based on an operation mode designation signal input from the outside of the image sensor A, the LED light emission unit 2 emits light source pulsed light at a light emission frequency corresponding to the operation mode.

The pixel array 2 is an aggregate of a plurality of pixels G two-dimensionally arranged. As illustrated in FIG. 1, the pixel array 2 has, for example, 134 pixels in the column direction and 132 pixels in the row direction. Thus, the pixel array 2 includes a total of 17688 pixels G arranged orthogonally. The column direction corresponds to the horizontal direction (left-right direction) of the two dimensional image, and the row direction corresponds to the vertical direction (up-down direction) of the two dimensional image.

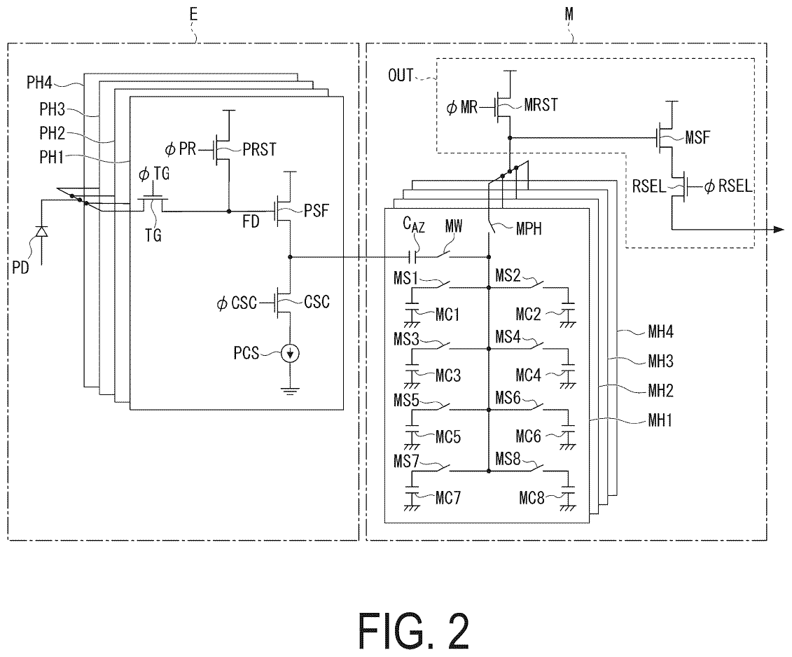

As illustrated in FIG. 1 and FIG. 2, each of the pixels G in the pixel array 2 includes a pixel portion E and a pixel memory M. As illustrated in FIG. 2, the pixel portion E includes a charge transport photodiode PD and four voltage signal generation units PH1 to PH4 (tap circuits), and performs photoelectric conversion on incident light from the imaging target object, that is, light which is a light source pulse reflected by the imaging target object, to collect photocharges and generate a voltage signal.

The charge transport photodiode PD is a light reception element that sequentially receives the incident light, that is, the reflected light of the light source pulsed light, from the imaging target object. That is, the charge transport photodiode PD generates charges (photocharges) therein by photoelectrically converting the incident light, and performs high-speed transportation and supplying of the photocharges to the four voltage signal generation units PH1 to PH4.

The four voltage signal generation units PH1 to PH4 form a modulation circuit that executes modulation processing on the photocharge as a whole. The four voltage signal generation units PH1 to PH4 acquire the photocharges of the charge transport photodiode PD at four (a plurality of) different timings (charge acquisition timings) and convert the photocharges into four (a plurality of) voltage signals V1 to V4. These four voltage signals V1 to V4 are detection signals indicating the distance between the image sensor A and the imaging target object as a whole.

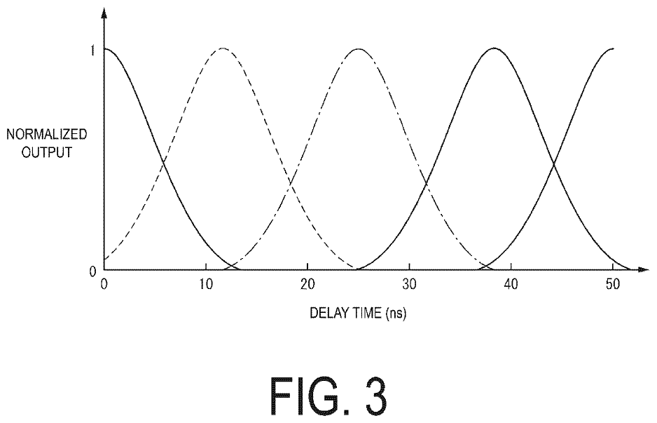

The image sensor A according to the first embodiment is a TOF image sensor, and detects a distance to the imaging target object based on a reception timing of incident light (reflected light) which is the light source pulsed light LED_{HP} and the light source pulsed light LED_{HS} reflected by the imaging target object. Since the four voltage signal generation units PH1 to PH4 acquire photocharges from the charge transport photodiode PD at four different timings, the four voltage signals V1 to V4 have a magnitude relationship based on the reception timing of incident light as illustrated as normalized outputs in FIG. 3.

As illustrated in FIG. 2, each of the four voltage signal generation units PH1 to PH4 includes a transfer gate transistor TG, a pixel source follower driver PSF, a pixel source follower drive selection switch CSC, a pixel current source PCS, and a pixel reset gate PRST. As illustrated in FIG. 2, the transfer gate transistor TG, the pixel source follower driver PSF, the pixel source follower drive selection switch CSC, and the pixel reset gate PRST are all MOS field effect transistors.

Of the four voltage signal generation units PH1 to PH4, the first voltage signal generation unit PH1 will be representatively described. The transfer gate transistor TG has the source terminal connected to the cathode terminal of the charge transport photodiode PD, the drain terminal connected to one end of a floating diffusion FD and to the source terminal of a preset transistor PRST, and has the gate terminal connected to the pair of modulation pulse generation units 5A and 5B.

Thus, the transfer gate transistor TG is provided between the charge transport photodiode PD and the floating diffusion FD connected to the gate terminal of the pixel source follower driver PSF, acquires the photocharge of the charge transport photodiode PD and transfers the photocharge to the floating diffusion FD during a period when a first modulation pulse φTG1 (see FIG. 5) applied to the gate terminal is high (Hi).

The floating diffusion FD has one end electrically connected to the drain terminal of the transfer gate transistor TG, and the other end connected to the gate terminal of the pixel source follower driver PSF. The floating diffusion FD is provided between the transfer gate transistor TG and the pixel source follower driver PSF, and converts the photocharge input from the transfer gate transistor TG into the first voltage signal V1 via its own floating capacitance (electrostatic capacitance).

The pixel source follower driver PSF has the gate terminal connected to the other end of the floating diffusion FD, the source terminal connected to the drain terminal of the pixel source follower drive selection switch CSC and a subsequent stage circuit, and the drain terminal connected to a power supply. The pixel source follower driver PSF forms an impedance conversion unit together with a constant current source PCS, reduces the impedance of the first voltage signal V1 applied from the other end of the floating diffusion FD to the gate terminal, and outputs the resultant voltage signal to the subsequent stage circuit.

The pixel source follower drive selection switch CSC has the drain terminal connected to the source terminal of the pixel source follower driver PSF, the source terminal connected to the inflow end of the constant current source PCS, and the gate terminal connected to the pixel control unit 3. The pixel source follower drive selection switch CSC is a switch for turning ON/OFF the pixel source follower driver PSF.

A source follower switching pulse φCSC is input from the pixel control unit 3 to the gate terminal of the pixel source follower drive selection switch CSC. The pixel source follower drive selection switch CSC is in the conductive state when the source follower switching pulse φCSC is high (Hi), and sets the pixel source follower driver PSF to the ON state. The pixel source follower drive selection switch CSC is in the non-conductive state when the source follower switching pulse φCSC is low (Low), and sets the pixel source follower driver PSF to the OFF state.

The pixel current source PCS has an input end connected to the source terminal of the pixel source follower drive selection switch CSC and has an output end grounded. The pixel current source PCS is a constant current source for setting a source current for the pixel source follower driver PSF, and includes, for example, a MOS transistor.

The pixel reset gate PRST has the source terminal connected to the floating diffusion FD and the gate terminal of the pixel source follower driver PSF, the drain terminal connected to the power supply, and the gate terminal connected to the global control pulse generation unit 6. A pixel reset pulse φPR is input from the global control pulse generation unit 6 to the gate terminal of the pixel reset gate PRST. Such a pixel reset gate PRST is a reset circuit that resets the floating diffusion FD to a predetermined voltage based on the pixel reset pulse φPR.

The pixel memory M is provided adjacent to the above-described pixel portion E, and includes four (a plurality of) memory arrays MH1 to MH4 and a single pixel output unit OUT. The pixel memory M sequentially acquires the plurality of voltage signals V1 to V4 related to the plurality of charge acquisition timings from the pixel portion E, and individually and integrally stores a plurality of detected voltages V1a to V4a based on the plurality of voltage signals V1 to V4. The pixel memory M reads the detected voltages V1a to V4a integrally stored in the four memory arrays MH1 to MH4, respectively, and outputs the detected voltages to a column signal line (vertical signal line).

Of the four memory arrays MH1 to MH4, the first memory array MH1 is provided corresponding to the first voltage signal generation unit PH1, and integrally stores a plurality of the first detected voltages V1a related to a plurality of charge acquisition timings by sequentially acquiring a plurality of the first voltage signals V1 related to the plurality of charge acquisition timings from the first voltage signal generation unit PH1. The first memory array MH1 forms a first exposure circuit together with the first voltage signal generation unit PH1.

The second memory array MH2 is provided corresponding to the second voltage signal generation unit PH2, and integrally stores the second detected voltages V2a related to a plurality of charge acquisition timings by sequentially acquiring the second voltage signals V2 related to the plurality of charge acquisition timings from the second voltage signal generation unit PH2. The second memory array MH2 forms a second exposure circuit together with the second voltage signal generation unit PH2.

The third memory array MH3 is provided corresponding to the third voltage signal generation unit PH3, and integrally stores the third detected voltages V3a related to a plurality of charge acquisition timings by sequentially acquiring the third voltage signals V3 related to the plurality of charge acquisition timings from the third voltage signal generation unit PH3. The third memory array MH3 forms a third exposure circuit together with the third voltage signal generation unit PH3.

The fourth memory array MH4 is provided corresponding to the fourth voltage signal generation unit PH4, and integrally stores the fourth detected voltages V4a related to a plurality of charge acquisition timings by sequentially acquiring the fourth voltage signals V4 related to the plurality of charge acquisition timings from the fourth voltage signal generation unit PH4.

The fourth memory array MH4 forms a fourth exposure circuit together with the fourth voltage signal generation unit PH4.

As illustrated in FIG. 2, each of the four memory arrays MH1 to MH4 includes a coupling capacitor C_{AZ}, a write gate MW, eight memory selection gates MS1 to MS8, eight memory cells MC1 to MC8, and a read gate MPH.

Of the four memory arrays MH1 to MH4, the first memory array MH1 will be representatively described. The coupling capacitor C_{AZ} has one end connected to the source terminal of the pixel source follower driver PSF and the drain terminal of the pixel source follower drive selection switch CSC, and the other end connected to one end of the write gate MW.

The coupling capacitor C_{AZ} is provided to cancel DC-offset between the first memory array MH1 and the first voltage signal generation unit PH1. Specifically, the coupling capacitor C_{AZ} capacitively couples the first memory array MH1 and the first voltage signal generation unit PH1 to each other, thereby blocking the inflow of a DC signal from the first voltage signal generation unit PH1 to the first memory array MH1.

The write gate MW has one end connected to the other end of the coupling capacitor C_{AZ}, and the other end connected to one end of each of the eight memory selection gates MS1 to MS8 and one end of the read gate MPH. The open/closed state of the write gate MW is set using a write pulse φMW input from the global control pulse generation unit 6.

Specifically, the write gate MW is a switch that sets connection/disconnection between the first voltage signal generation unit PH1 and the eight memory cells MC1 to MC8 based on the write pulse φMW. The write gate MW is set to the closed state when the first detected voltage V1a is stored in the first memory array MH1 based on the first voltage signal V1 generated by the first voltage signal generation unit PH1.

The eight memory selection gates MS1 to MS8 are provided corresponding to the eight memory cells MC1 to MC8, and form a series circuit with the corresponding memory cells MC1 to MC8. The eight memory selection gates MS1 to MS8 are switches that selectively set connection/disconnection between the corresponding memory cells MC1 to MC8 and the first voltage signal generation unit PH1.

Of the eight memory selection gates MS1 to MS8, the first memory selection gate MS1 has one end connected to the other end of the write gate MW, one end of each of the seven memory selection gates MS2 to MS8, and one end of the read gate MPH, and has the other end connected to one end of the first memory cell MC1. Thus, the first memory selection gate MS1 forms a series circuit with the first memory cell MC1, and sets connection/disconnection between the first memory cell MC1 and the first voltage signal generation unit PH1 based on a first cell selection pulse φMS1 input from the global control pulse generation unit 6.

The second memory selection gate MS2 has one end connected to the other end of the write gate MW, one end of each of the seven memory selection gates MS1 and MS3 to MS8, and one end of the read gate MPH, and has the other end connected to one end of the second memory cell MC2. Thus, the second memory selection gate MS2 forms a series circuit with the second memory cell MC2, and sets connection/disconnection between the second memory cell MC2 and the first voltage signal generation unit PH1 based on a second cell selection pulse φMS2 input from the global control pulse generation unit 6.

The third memory selection gate MS3 has one end connected to the other end of the write gate MW, one end of each of the seven memory selection gates MS1, MS2, and MS4 to MS8, and one end of the read gate MPH, and has the other end connected to one end of the third memory cell MC3. Thus, the third memory selection gate MS3 forms a series circuit with the third memory cell MC3, and sets connection/disconnection between the third memory cell MC3 and the first voltage signal generation unit PH1 based on a third cell selection pulse φMS3 input from the global control pulse generation unit 6.

The fourth memory selection gate MS4 has one end connected to the other end of the write gate MW, one end of each of the seven memory selection gates MS1 to MS3, and MS5 to MS8, and one end of the read gate MPH, and has the other end connected to one end of the fourth memory cell MC4. Thus, the fourth memory selection gate MS4 forms a series circuit with the fourth memory cell MC4, and sets connection/disconnection between the fourth memory cell MC4 and the first voltage signal generation unit PH1 based on a fourth cell selection pulse φMS4 input from the global control pulse generation unit 6.

The fifth memory selection gate MS5 has one end connected to the other end of the write gate MW, one end of each of the seven memory selection gates MS1 to MS4, and MS6 to MS8, and one end of the read gate MPH, and has the other end connected to one end of the fifth memory cell MC5. Thus, the fifth memory selection gate MS5 forms a series circuit with the fifth memory cell MC5, and sets connection/disconnection between the fifth memory cell MC5 and the first voltage signal generation unit PH1 based on a fifth cell selection pulse φMS5 input from the global control pulse generation unit 6.

The sixth memory selection gate MS6 has one end connected to the other end of the write gate MW, one end of each of the seven memory selection gates MS1 to MS5, MS7, and MS8, and one end of the read gate MPH, and has the other end connected to one end of the sixth memory cell MC6. Thus, the sixth memory selection gate MS6 forms a series circuit with the sixth memory cell MC6, and sets connection/disconnection between the sixth memory cell MC6 and the first voltage signal generation unit PH1 based on a sixth cell selection pulse φMS6 input from the global control pulse generation unit 6.

The seventh memory selection gate MS7 has one end connected to the other end of the write gate MW, one end of each of the seven memory selection gates MS1 to MS6 and MS8, and one end of the read gate MPH, and has the other end connected to one end of the seventh memory cell MC7. Thus, the seventh memory selection gate MS7 forms a series circuit with the seventh memory cell MC7, and sets connection/disconnection between the seventh memory cell MC7 and the first voltage signal generation unit PH1 based on a seventh cell selection pulse φMS7 input from the global control pulse generation unit 6.

The eighth memory selection gate MS8 has one end connected to the other end of the write gate MW, one end of each of the seven memory selection gates MS1 to MS7 and one end of the read gate MPH, and has the other end connected to one end of the eighth memory cell MC8. Thus, the eighth memory selection gate MS8 forms a series circuit with the eighth memory cell MC8, and sets connection/disconnection between the eighth memory cell MC8 and the first voltage signal generation unit PH1 based on an eighth cell selection pulse φMS8 input from the global control pulse generation unit 6.

The eight memory cells MC1 to MC8 are analog memories (capacitors) that have predetermined electrostatic capacitance and integrally store the plurality of first detected voltages V1a based on the plurality of first voltage signals V1 related to the first charge acquisition timing, generated by the first voltage signal generation unit PH1. The eight (plurality of) memory cells MC1 to MC8 correspond to eight (plurality of) storage periods including the first charge acquisition timing, and integrally store the plurality of first detected voltages V1a in the corresponding storage period.

Among the eight memory cells MC1 to MC8, the first memory cell MC1 has one end connected to the other end of the first memory selection gate MS1 and the other end grounded. The first memory cell MC1 forms a first series circuit together with the first memory selection gate MS1. The first memory cell MC1 integrally stores a plurality of first detected voltages V11a related to a plurality of charge acquisition timings in a first storage period in which the write gate MW and the first memory selection gate MS1 are in the closed state. The first storage period corresponds to “Sub-Frame #1” (first sub-frame) illustrated in FIG. 5.

Specifically, the first voltage signal V1 related to the first charge acquisition timing generated by the first voltage signal generation unit PH1 in the first storage period is applied to the first memory cell MC1. The first memory cell MC1 integrally stores the plurality of first detected voltages V11a based on the first voltage signal V1 in the first storage period.

The second memory cell MC2 has one end connected to the other end of the second memory selection gate MS2 and the other end grounded. The second memory cell MC2 forms a second series circuit together with the second memory selection gate MS2. The second memory cell MC2 integrally stores a plurality of first detected voltages V12a related to a plurality of charge acquisition timings in a second storage period in which the write gate MW and the second memory selection gate MS2 are in the closed state. The second storage period corresponds to “Sub-Frame #2” (second sub-frame) subsequent to “Sub-Frame #1”.

Specifically, the plurality of first voltage signals V1 related to a plurality of charge acquisition timings generated by the first voltage signal generation unit PH1 in the second storage period, different from the first storage period, are applied to the second memory cell MC2. The second memory cell MC2 integrally stores the plurality of first detected voltages V12a based on the plurality of first voltage signals V1 in the second storage period.

The third memory cell MC3 has one end connected to the other end of the third memory selection gate MS3 and the other end grounded. The third memory cell MC3 forms a third series circuit together with the third memory selection gate MS3. The third memory cell MC3 integrally stores a plurality of first detected voltages V13a related to a plurality of charge acquisition timings in a third storage period in which the write gate MW and the third memory selection gate MS3 are in the closed state. The third storage period corresponds to “Sub-Frame #3” (third sub-frame) subsequent to “Sub-Frame #2”.

Specifically, the plurality of first voltage signals V1 related to a plurality of charge acquisition timings generated by the first voltage signal generation unit PH1 in the third storage period different from the first and the second storage periods with the third memory selection gate MS3 being in the closed state, are applied to the third memory cell MC3. The third memory cell MC3 integrally stores the plurality of first detected voltages V13a based on the plurality of first voltage signals V1 in the third storage period.

The fourth memory cell MC4 has one end connected to the other end of the fourth memory selection gate MS4 and the other end grounded. The fourth memory cell MC4 forms a fourth series circuit together with the fourth memory selection gate MS4. The fourth memory cell MC4 integrally stores a plurality of first detected voltages V14a related to a plurality of charge acquisition timings in a fourth storage period in which the write gate MW and the fourth memory selection gate MS4 are in the closed state. The fourth storage period corresponds to “Sub-Frame #4” (fourth sub-frame) subsequent to “Sub-Frame #3”.

Specifically, the plurality of first voltage signals V1 related to a plurality of charge acquisition timings generated by the first voltage signal generation unit PH1 in the fourth storage period different from the first to the third storage periods with the fourth memory selection gate MS4 being in the closed state, are applied to the fourth memory cell MC4. The fourth memory cell MC4 integrally stores the plurality of first detected voltages V14a based on the plurality of first voltage signals V1 in the fourth storage period.

The fifth memory cell MC5 has one end connected to the other end of the fifth memory selection gate MS5 and the other end grounded. The fifth memory cell MC5 forms a fifth series circuit together with the fifth memory selection gate MS5. The fifth memory cell MC5 integrally stores a plurality of first detected voltages V15a related to a plurality of charge acquisition timings in a fifth storage period in which the write gate MW and the fifth memory selection gate MS5 are in the closed state. The fifth storage period corresponds to “Sub-Frame #5” (fifth sub-frame) subsequent to “Sub-Frame #4”.

Specifically, the plurality of first voltage signals V1 related to a plurality of charge acquisition timings generated by the first voltage signal generation unit PH1 in the fifth storage period different from the first to the fourth storage periods with the fifth memory selection gate MS5 being in the closed state, are applied to the fifth memory cell MC5. The fifth memory cell MC5 integrally stores the plurality of first detected voltages V15a based on the plurality of first voltage signals V1 in the fifth storage period.

The sixth memory cell MC6 has one end connected to the other end of the sixth memory selection gate MS6 and the other end grounded. The sixth memory cell MC6 forms a sixth series circuit together with the sixth memory selection gate MS6. The sixth memory cell MC6 integrally stores a plurality of first detected voltages V16a related to a plurality of charge acquisition timings in a sixth storage period in which the write gate MW and the sixth memory selection gate MS6 are in the closed state. The sixth storage period corresponds to “Sub-Frame #6” (sixth sub-frame) subsequent to “Sub-Frame #5”.

Specifically, the plurality of first voltage signals V1 related to a plurality of charge acquisition timings generated by the first voltage signal generation unit PH1 in the sixth storage period different from the first to the fifth storage periods with the sixth memory selection gate MS6 being in the closed state, are applied to the sixth memory cell MC6. The sixth memory cell MC6 integrally stores the plurality of first detected voltages V16a based on the plurality of first voltage signals V1 in the sixth storage period.

The seventh memory cell MC7 has one end connected to the other end of the seventh memory selection gate MS7 and the other end grounded. The seventh memory cell MC7 forms a seventh series circuit together with the seventh memory selection gate MS7. The seventh memory cell MC7 integrally stores a plurality of first detected voltages V17a related to a plurality of charge acquisition timings in a seventh storage period in which the write gate MW and the seventh memory selection gate MS7 are in the closed state. The seventh storage period corresponds to “Sub-Frame #7” (seventh sub-frame) subsequent to “Sub-Frame #6”.

Specifically, the plurality of first voltage signals V1 related to a plurality of charge acquisition timings generated by the first voltage signal generation unit PH1 in the seventh storage period different from the first to the sixth storage periods with the seventh memory selection gate MS7 being in the closed state, are applied to the seventh memory cell MC7. The seventh memory cell MC7 integrally stores the plurality of first detected voltages V17a based on the plurality of first voltage signals V1 in the seventh storage period.

The eighth memory cell MC8 has one end connected to the other end of the eighth memory selection gate MS8 and the other end grounded. The eighth memory cell MC8 forms an eighth series circuit together with the eighth memory selection gate MS8. The eighth memory cell MC8 integrally stores a plurality of first detected voltages V18a related to a plurality of charge acquisition timings in an eighth storage period in which the write gate MW and the eighth memory selection gate MS8 are in the closed state. The eighth storage period corresponds to “Sub-Frame #8” (eighth sub-frame) subsequent to “Sub-Frame #7” as illustrated in FIG. 5.

Specifically, the plurality of first voltage signals V1 related to a plurality of charge acquisition timings generated by the first voltage signal generation unit PH1 in the eighth storage period different from the first to the seventh storage periods with the eighth memory selection gate MS8 being in the closed state, are applied to the eighth memory cell MC8. The eighth memory cell MC8 integrally stores the plurality of first detected voltages V18a based on the plurality of first voltage signals V1 in the eighth storage period.

The read gate MPH has one end connected to the other end of the write gate MW and one end of each of the eight memory selection gates MS1 to MS8, and the other end connected to the other end of the read gate MPH of the other memory arrays MH2 to MH4 and the input end of the pixel output unit OUT. The open/closed state of the read gate MPH is set by a memory reset pulse φMR input from the global control pulse generation unit 6.

Depending on the open/closed state of the eight memory selection gates MS1 to MS8, the eight memory cells MC1 to MC8 can be connected to the input end of the pixel output unit OUT when the read gate MPH is in the closed state. The read gate MPH is set to the closed state based on the memory reset pulse φMR when the first detected voltages V11a to V18a are read from the eight memory cells MC1 to MC8.

The pixel output unit OUT is an output circuit that outputs four (a plurality of) detected voltages V1a to V4a based on the four (plurality of) voltage signals V1 to V4, to a column signal line (vertical signal line). The pixel output unit OUT reads the detected voltages V1a to V4a stored in the four memory arrays MH1 to MH4 in a predetermined order, sequentially outputs the read detected voltages to the column signal line, and resets the detected voltages V1a to V4a to a predetermined voltage.

As illustrated in FIG. 2, the pixel output unit OUT includes a memory reset gate MRST, a memory source follower driver MSF, and a pixel selection switch RSEL. The memory reset gate MRST has the source terminal connected to the other end of the read gate MPH of each of the four memory arrays MH1 to MH4 and the gate terminal of the memory source follower driver MSF, the drain terminal connected to the power supply, and the gate terminal connected to the global control pulse generation unit 6.

The memory reset pulse φMR is input from the global control pulse generation unit 6 to the gate terminal of the memory reset gate MRST. This memory reset gate MRST becomes conductive in a state where the memory reset pulse φMR is high (Hi), and resets the detected voltages V1a to V4a of the memory arrays MH1 to MH4 to a predetermined voltage. The memory reset gate MRST is in the non-conductive state when the memory reset pulse φMR is low, and enables application of the detected voltages V1a to V4a of the memory arrays MH1 to MH4 to the memory source follower driver MSF.

The memory source follower driver MSF has the gate terminal connected to the other end of the read gate MPH of each of the four memory arrays MH1 to MH4 and the source terminal of the memory reset gate MRST, the source terminal connected to the drain terminal of the pixel selection switch RSEL, and the drain terminal connected to the power supply. The memory source follower driver MSF forms an impedance voltage signal generation unit together with the pixel selection switch RSEL, reduces the impedance of the detected voltages V1a to V4a read from the four memory arrays MH1 to MH4, and outputs the detected voltages to the column signal line (vertical signal line) connected to the source terminal of the pixel selection switch RSEL.

The pixel selection switch RSEL has the drain terminal connected to the source terminal of the memory source follower driver MSF, the source terminal connected to the external column signal line (vertical signal line), and the gate terminal connected to the row selection unit 7. A row selection pulse φRSEL is input from the row selection unit 7 to the gate terminal of the pixel selection switch RSEL. The pixel selection switch RSEL transitions to the conductive state based on the row selection pulse φRSEL and outputs the detected voltages V1a to V4a read from the four memory arrays MH1 to MH4 to the column signal line (vertical signal line).

The pixel control unit 3 is a control circuit that controls generation of various bias power supplies and control pulses supplied to the pixel array 1. Specifically, the pixel control unit 3 integrally controls the modulation pulse generation units 5A and 5B, the global control pulse generation unit 6, the row selection unit 7, the column selection unit 8, the signal reading unit 9, the bias power supply unit 10, the read drive unit 11, the output unit 12, and the like based on an operation mode designation signal, a reference clock (CLK) separately input from the outside, and the like.

The pixel control unit 3 includes a pulse generation circuit that generates the source follower switching pulse φCSC. As illustrated in FIG. 2, the source follower switching pulse φCSC is a control pulse that is supplied to the gate terminal of the pixel source follower drive selection switch CSC, and turns ON/OFF the pixel source follower driver PSF. The pixel control unit 3 generates such a source follower switching pulse φCSC for each pixel G of the pixel array 1 and outputs the pulse to each pixel G.

The clock control unit 4A is a clock branch circuit having a tree structure. Since the clock control unit 4A has a tree structure, the reference clock is branched by the number of pixels in a state with the time lag minimized, and is supplied to the modulation pulse generation units 5A and 5B, the global control pulse generation unit 6, the row selection unit 7, the column selection unit 8, the signal reading unit 9, the read drive unit 11, the output unit 12, and the like.

The clock control unit 4B is a clock branch circuit having a tree structure similar to that of the clock control unit 4A. As with the clock control unit 4A, with the clock control unit 4B, the reference clock is branched by the number of pixels in a state with the time lag minimized, and is supplied to the modulation pulse generation units 5A and 5B, the global control pulse generation unit 6, the row selection unit 7, the column selection unit 8, the signal reading unit 9, the read drive unit 11, the output unit 12, and the like.

The modulation pulse generation unit 5A is a pulse generation circuit that generates the four modulation pulses φTG1 to φTG4 for each pixel G. The modulation pulse generation unit 5A generates the four modulation pulses φTG1 to φTG4 that are at predetermined frequencies and are in a certain phase relationship, by executing predetermined timing processing on the reference clock input from the clock control unit 4A.

The repetition frequencies of the four modulation pulses φTG1 to φTG4 are the same as the light emission frequency of the light source pulsed light. The four modulation pulses φTG1 to φTG4 are pulse signals with a duty ratio of 25%, and are in a relationship in which the timing is sequentially shifted by the pulse width.

That is, among the four modulation pulses φTG1 to φTG4, the first modulation pulse φTG1 is a pulse signal with the same phase as the light source pulsed light as illustrated in FIG. 5. As illustrated in FIG. 5, the second modulation pulse φTG2 is a pulse signal whose timing is delayed by the pulse width with respect to the first modulation pulse φTG1 (that is, the light source pulsed light). The third modulation pulse φTG3 is a pulse signal whose timing is delayed by the pulse width with respect to the second modulation pulse φTG2.

Further, the fourth modulation pulse φTG4 is a pulse signal whose timing is delayed by the pulse width with respect to the third modulation pulse φTG3. The four modulation pulses φTG1 to φTG4 are in such a timing relationship with the light source pulsed light that the next light source pulsed light is emitted in synchronization with the timing at which the fourth modulation pulse φTG4 transitions from the high level to the low level.

Alternatively, the relationship may be such that the next light source pulsed light is emitted when a predetermined period of time elapses after the fourth modulation pulse φTG4 has transitioned from the high level to the low level. In this case, the duty ratio of the light source pulsed light can be reduced, whereby power consumption and heat generation of the image sensor A can be suppressed.

The four modulation pulses φTG1 to φTG4 are applied to the gate terminal of the transfer gate transistor TG in each of the four voltage signal generation units PH1 to PH4. The first modulation pulse φTG1 is applied to the gate terminal of the transfer gate transistor TG in the first voltage signal generation unit PH1, and the second modulation pulse φTG2 is applied to the gate terminal of the transfer gate transistor TG in the second voltage signal generation unit PH2.

The third modulation pulse φTG3 is applied to the gate terminal of the transfer gate transistor TG in the third voltage signal generation unit PH3, and the fourth modulation pulse φTG4 is applied to the gate terminal of the transfer gate transistor TG in the fourth voltage signal generation unit PH4. The first to the fourth modulation pulses φTG1 to φTG4 are control signals for designating the charge acquisition timings in the first to fourth voltage signal generation units PH1 to PH4.

The pulse width (high period) of the four modulation pulses φTG1 to φTG4 is a modulation time Tp in the modulation circuit according to the first embodiment. As illustrated in FIG. 5, the modulation time Tp is a period corresponding to the light emission pulse width Tc of the light source pulsed light.

The modulation pulse generation unit 5B is the same pulse generation circuit as the above-described modulation pulse generation unit 5A, and generates the four modulation pulses φTG1 to φTG4 for each pixel G. The modulation pulse generation unit 5B generates the four modulation pulses φTG1 to φTG4, by executing predetermined timing processing on the reference clock input from the clock control unit 4A.

The global control pulse generation unit 6 is a pulse generation circuit that generates a global control pulse. The global control pulse is an aggregate of a plurality of control paths and is a control pulse other than the four modulation pulses φTG1 to φTG4 used in each pixel G of the pixel array 1. The global control pulse includes the pixel reset pulse φPR, the write pulse φMW, the memory reset pulse φMR, and the cell selection pulses φMS1 to φMS8.

The pixel reset pulse φPR is output to the gate terminal of the pixel reset gate PRST described above, and sets the conductive/non-conductive state of the pixel reset gate PRST. The write pulse φMW is output to the write gate MW to set the open/closed state of the write gate MW. The memory reset pulse φMR is output to the gate terminal of the memory reset gate MRST to set the conductive/non-conductive state of the memory reset gate MRST. Further, the cell selection pulses φMS1 to φMS8 are output to the eight memory selection gates MS1 to MS8, respectively, to set the open/closed states of the memory selection gates MS1 to MS8.

The row selection unit 7 is a vertical shift register circuit that designates the pixel G (pixel row) in the row direction in the pixel array 2. The row selection unit 7 generates the row selection pulse φRSEL for sequentially switching the pixel row in a predetermined cycle and outputs the row selection pulse φRSEL to the pixel output unit OUT of each pixel G. One of the 132 pixel rows in the pixel array 2 is selectively selected by the row selection pulse φRSEL.

In addition, the row selection unit 7 generates four state setting pulses φPH1 to φPH4 and outputs the pulses to each pixel G. The state setting pulses φPH1 to (PH4 are control pulses for setting the above-described four voltage signal generation units PH1 to PH4 to the active state.

The column selection unit 8 is a horizontal shift register circuit that designates the pixel G (pixel column) in the column direction in the pixel array 2. The column selection unit 8 generates a column selection pulse for sequentially switching the pixel column in a predetermined cycle and outputs the pulse to each pixel G. One of the 134 pixel columns in the pixel array 2 is selectively selected by the column selection pulse and connected to a column signal line (horizontal signal line).

The signal reading unit 9 is a circuit for reading the first to the fourth detected voltages V1a to V4a from the pixel memory M of each pixel G in the pixel array 2, and includes a column current source circuit, a vertical signal line reset circuit, and the like. The signal reading unit 9 samples the first to the fourth detected voltages V1a to V4a sequentially input from each pixel G of the pixel array 2 in a predetermined order, and outputs the sampled voltages to the output unit 12 as read signals.

The bias power supply unit 10 is a power supply circuit that generates various bias power supplies used in the signal reading unit 9. The bias power supply unit 10 supplies various bias power supplies generated therein to the column current source circuit, the vertical signal line reset circuit, and the like.

The read drive unit 11 is a drive circuit that drives various read pulses used in the signal reading unit 9. The read drive unit 11 outputs various read pulses generated therein to the column current source circuit, the vertical signal line reset circuit, and the like.

The output unit 12 is an amplifier that amplifies the read signal input from the signal reading unit 9 and outputs the amplified signal to the outside. The output unit 12 outputs the read signal amplified by a predetermined amplification factor to the outside as an output signal of the image sensor A.

The image sensor A according to the first embodiment is a 4-tap TOF image sensor in which the number (tap number) of tap circuits (voltage signal generation units PH1 to PH4) forming the modulation circuit is “4”. The basic concept of such a 4-Tap TOF image sensor is well known as described in Non-Patent Document 1 and the like.

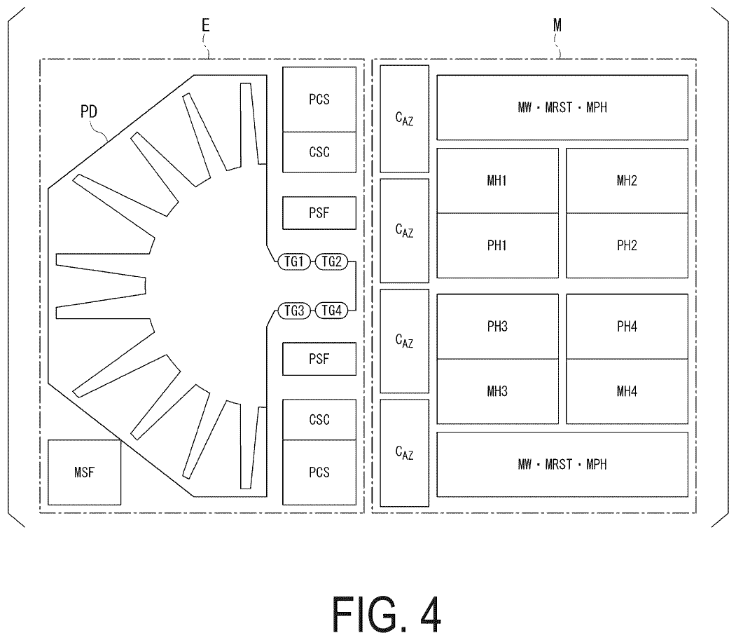

Next, the layout of circuit elements in each pixel G of the image sensor A will be described with reference to FIG. 4. Since the image sensor A is formed as a semiconductor integrated circuit (IC) as described above, the circuit elements of each pixel G are laid out on a semiconductor chip (IC chip).

In FIG. 4, the transfer gate transistors TGs, which are components of the four voltage signal generation units PH1 to PH4, are illustrated separately from the voltage signal generation units PH1 to PH4. In FIG. 4, the first transfer gate transistor TG in the first voltage signal generation unit PH1 is denoted by “TG1”, the second transfer gate transistor TG in the second voltage signal generation unit PH2 is denoted by “TG2”, the third transfer gate transistor TG in the third voltage signal generation unit PH3 is denoted by “TG3”, and the fourth transfer gate transistor TG in the fourth voltage signal generation unit PH4 is denoted by “TG4”.

In FIG. 4, coupling capacitors CAZ, which are components of four (a plurality of) memory arrays MH1 to MH4, are illustrated separately from the memory arrays MH1 to MH4. The coupling capacitor C_{AZ} has a relatively large electrostatic capacitance, and thus is a circuit element that occupies a relatively large area. For the coupling capacitor C_{AZ} and the analog memory cells MC1 to MC8, a silicon trench capacitor having a high capacitance area density or a metal-insulator-metal (MIM) capacitor formed between interconnect layers may be used.

In addition, a configuration may be applied in which a semiconductor substrate on which the charge transport photodiode PD is formed and a semiconductor substrate on which the coupling capacitor CAZ and the analog memory cells MC1 to MC8 are formed are three dimensionally stacked and are connected to each other by electrical wiring for each pixel. Such a configuration is advantageous in terms of increase in the number of pixels with the pixel size reduced, and is also advantageous in terms of increase in the sensitivity because the aperture ratio of the charge transport photodiode PD can be increased.

In the pixel portion E, the charge transport photodiodes PD are main elements of the four voltage signal generation units PH1 to PH4, and occupy most of the area of the region of the pixel portion E in order to increase the light-reception area for incident light as much as possible. The four transfer gate transistors TG1 to TG4 are arranged at positions closest to the pixel memory M in the region of the pixel portion E, and are arranged so as to be equidistant from the charge transport photodiode PD as much as possible.

In the pixel memory M, the four voltage signal generation units PH1 to PH4 are arranged so as to be equidistant from the four transfer gate transistors TG1 to TG4 as much as possible.

Each of the coupling capacitors CAZ in the four memory arrays MH1 to MH4 is disposed at a position closest to the pixel portion E in the pixel memory M.

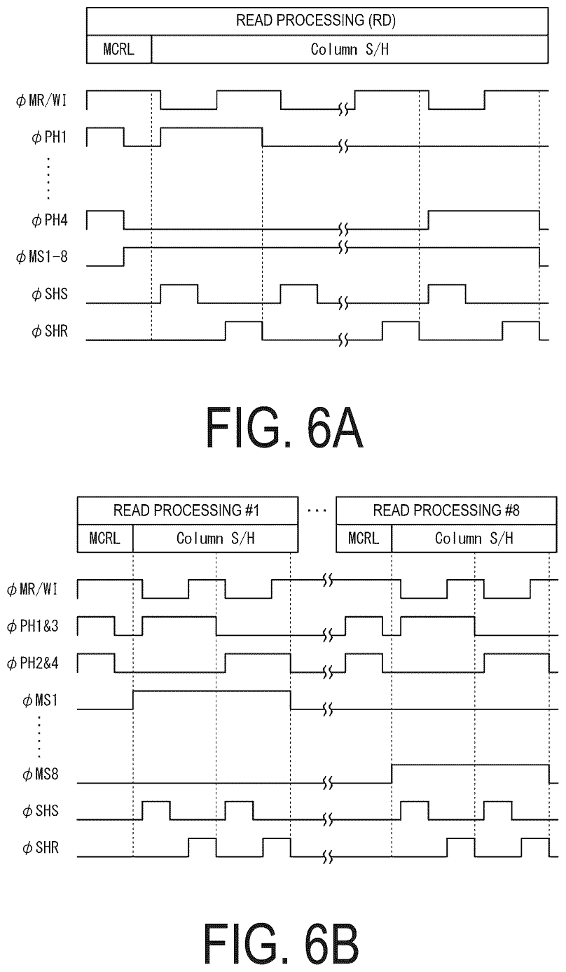

Next, the operation of the image sensor A according to the first embodiment will be described in detail with reference to FIGS. 5, 6A and 6B. The operation of the image sensor A corresponds to the method for driving the image sensor A according to the first embodiment.

First, an exposure operation (exposure processing) of the image sensor A will be described with reference to the timing chart of FIG. 5. In this exposure processing, in the first to the fourth exposure circuits, photocharges generated in the charge transport photodiode PD based on incident light are acquired by the first to fourth voltage signal generation units PH1 to PH4 and converted into the first to the fourth voltage signals V1 to V4.

In the exposure processing, the first to the fourth voltage signals V1 to V4 are supplied from the first to the fourth voltage signal generation units PH1 to PH4 to the first to the fourth memory arrays MH1 to MH4, respectively. Thus, the first to the fourth detected voltages V1a to V4a are integrally stored in the first to eighth memory cells MC1 to CM8 in a time division manner for each sub-frame.

Such exposure processing is substantially the same among the first to the fourth exposure circuits, but the processing timing differ among the circuits. Specifically, in the first to fourth exposure circuits, since the timings of the first to the fourth modulation pulses φTG1 to φTG4 generated by the modulation pulse generation unit 5B sequentially differ by the pulse width, as illustrated in FIG. 5, the processing timings of the exposure processing are shifted by the pulse widths of the first to fourth modulation pulses φTG1 to φTG4.

A description will be given on the first exposure circuit. First of all, a first floating diffusion FD1 in the first voltage signal generation unit PH1 is reset to a predetermined voltage, with the pixel reset gate PRST set to be in a conductive state. Specifically, when the pixel reset pulse φPR is set to a high (Hi) state, the pixel reset gate PRST is set to be in a conductive state, whereby the first floating diffusion FD1 is reset.

The first modulation pulse φTG1 synchronized with the light source pulsed light LED_{HP} under the HP mode is input to the gate terminal of the first transfer gate transistor TG1 in the first voltage signal generation unit PH1. The first transfer gate transistor TG1 transitions from the non-conductive state to the conductive state in synchronization with the first modulation pulse φTG1, acquires the photocharge of the charge transport photodiode PD, and transfers the photocharge to the first floating diffusion FD1.

Specifically, during a period in which the first modulation pulse φTG1 is at a high (Hi) level, the first transfer gate transistor TG1 is in the conductive state, and acquires the photocharge of the charge transport photodiode PD. The period during which the first modulation pulse φTG1 is at a high (Hi) level, that is, the period during which the first transfer gate transistor TG1 is in the conductive state corresponds to the charge acquisition timing in the first exposure circuit.

Here, in order to increase the number of photocharges and improve the signal-to-noise ratio, it is desirable that a plurality of light pulses are periodically emitted within one sub-frame period, and each time the pulse is emitted, the photocharges of the charge transport photodiode PD are transferred to the first floating diffusion FD1 via the transfer gate transistor TG1 in synchronization with the first modulation pulse φTG1.

The photocharge is converted into the first voltage signal V1 by the first floating diffusion FD1, and is output to the first memory array MH1 after having the impedance reduced by the pixel source follower driver PSF. That is, the photocharge is converted into the first voltage signal V1 by the floating capacitance (electrostatic capacitance) of the first floating diffusion FD1.

Here, as illustrated in FIG. 5, the first to the eighth cell selection pulses φMS1 to φMS8 generated by the global control pulse generation unit 6 transition from a low (Low) state to a high (Hi) state at timings that do not overlap each other on the time axis. Therefore, the first to the eighth memory selection gates MS1 to MS8 transition from the open state to the closed state at timings that do not overlap each other on the time axis, in accordance with the first to the eighth cell selection pulses φMS1 to φMS8.

Through such an opening/closing operation of the first to the eighth memory selection gates MS1 to MS8, the first voltage signal V1 is applied to one end of each of the first to the eighth memory cells MC1 to MC8 in the order of the first memory cell MC1->the second memory cell MC2->the third memory cell MC3->the fourth memory cell MC4->the fifth memory cell MC5->the sixth memory cell MC6->the seventh memory cell MC7->the eighth memory cell MC8.

Thus, the closed period of the first to the eighth memory selection gates MS1 to MS8 is a period in which the first voltage signal V1 is applied to any one of the first to the eighth memory cells MC1 to MC8. The first to the eighth memory cells MC1 to MC8 integrally store the first detected voltages V11a to V18a in a time division manner, based on the first voltage signal V1 in the first to eighth storage periods (Sub-Frames #1 to #8) in accordance with the opening/closing operation of the first to the eighth memory selection gates MS1 to MS8.

In the present embodiment, processing of acquiring the first to the fourth voltage signals V1 to V4 and storing, in a time division manner, the first to the fourth detected voltages V11a to V18a, V21a to V28a, V31a to V38a, and V41a to V48a based on the first to the fourth voltage signals V1 to V4 in the first to the eighth memory cells MC1 to MC8 is referred to as sub-frame processing.

In the first to the fourth memory arrays MH1 to MH4, the exposure processing for storing the first to the fourth detected voltages V11a, V21a, V31a, and V41a in the first memory cell MC1 is first sub-frame processing (Sub-Frame #1) illustrated in FIG. 5. With the first sub-frame processing, a plurality of first detected voltages V11a, V21a, V31a, and V41a related to a plurality of charge acquisition timings are stored in the first memory cells MC1 in MH1 to MH4, respectively, in the first storage period in which the write gate MW and the first memory selection gate MS1 are in the closed state.

In the first to the fourth memory arrays MH1 to MH4, the exposure processing for storing the first to the fourth detected voltages V11a to V18a, V21a to V28a, V31a to V38a, and V41a to V48a in the second memory cell MC2 is second sub-frame processing (Sub-Frame #2). With the second sub-frame processing, a plurality of first detected voltages V12a, V22a, V32a, and V42a related to a plurality of charge acquisition timings are stored in the second memory cells MC2 in MH1 to MH4, respectively, in the second storage period in which the write gate MW and the second memory selection gate MS2 are in the closed state.

In the first to the fourth memory arrays MH1 to MH4, the exposure processing for storing the first to the fourth detected voltages V11a to V18a, V21a to V28a, V31a to V38a, and V41a to V48a in the third memory cell MC3 is third sub-frame processing (Sub-Frame #3). With the third sub-frame processing, a plurality of detected voltages V13a, V23a, V33a, and V43a related to a plurality of charge acquisition timings are stored in the third memory cells MC3 in MH1 to MH4, respectively, in the third storage period in which the write gate MW and the third memory selection gate MS3 are in the closed state.

In the first to the fourth memory arrays MH1 to MH4, the exposure processing for storing the first to the fourth detected voltages V11a to V18a, V21a to V28a, V31a to V38a, and V41a to V48a in the fourth memory cell MC4 is fourth sub-frame processing (Sub-Frame #4). With the fourth sub-frame processing, a plurality of detected voltages V14a, V24a, V34a, and V44a related to a plurality of charge acquisition timings are stored in the fourth memory cells MC4 in MH1 to MH4, respectively, in the fourth storage period in which the write gate MW and the fourth memory selection gate MS4 are in the closed state.

In the first to the fourth memory arrays MH1 to MH4, the exposure processing for storing the first to the fourth detected voltages V11a to V18a, V21a to V28a, V31a to V38a, and V41a to V48a in the fifth memory cell MC5 is fifth sub-frame processing (Sub-Frame #5). With the fifth sub-frame processing, a plurality of detected voltages V15a, V25a, V35a, and V45a related to a plurality of charge acquisition timings are stored in the fifth memory cells MC5 in MH1 to MH4, respectively, in the fifth storage period in which the write gate MW and the fifth memory selection gate MS5 are in the closed state.

In the first to the fourth memory arrays MH1 to MH4, the exposure processing for storing the first to the fourth detected voltages V11a to V18a, V21a to V28a, V31a to V38a, and V41a to V48a in the sixth memory cell MC6 is sixth sub-frame processing (Sub-Frame #6). With the sixth sub-frame processing, a plurality of detected voltages V16a, V26a, V36a, and V46a related to a plurality of charge acquisition timings are stored in the sixth memory cells MC6 in MH1 to MH4, respectively, in the sixth storage period in which the write gate MW and the sixth memory selection gate MS6 are in the closed state.

In the first to the fourth memory arrays MH1 to MH4, the exposure processing for storing the first to the fourth detected voltages V11a to V18a, V21a to V28a, V31a to V38a, and V41a to V48a in the seventh memory cell MC7 is seventh sub-frame processing (Sub-Frame #7). With the seventh sub-frame processing, a plurality of detected voltages V17a, V27a, V37a, and V47a related to a plurality of charge acquisition timings are stored in the seventh memory cells MC7 in MH1 to MH4, respectively, in the seventh storage period in which the write gate MW and the seventh memory selection gate MS7 are in the closed state.

In the first to the fourth memory arrays MH1 to MH4, the exposure processing for storing the first to the fourth detected voltages V11a to V18a, V21a to V28a, V31a to V38a, and V41a to V48a in the eighth memory cell MC2 is eighth sub-frame processing (Sub-Frame #8) illustrated in FIG. 5. With the eighth sub-frame processing, a plurality of detected voltages V18a, V28a, V38a, and V48a related to a plurality of charge acquisition timings are stored in the eighth memory cells MC8 in MH1 to MH4, respectively, in the fifth storage period in which the write gate MW and the eighth memory selection gate MS8 are in the closed state.

A further description will be given on the exposure processing in the first embodiment. In the first to the eighth sub-frame processing (Sub-Frames #1 to #8), as illustrated in FIG. 5, photocharges sequentially generated in the charge transport photodiode PD based on the plurality of light source pulsed lights LED_{HP} are sequentially acquired by the four voltage signal generation units PH1 to PH4 at a plurality of charge acquisition timings based on the first to the fourth modulation pulses φTG1 to φTG4, and converted into the plurality of first to fourth voltage signals V1 to V4 that are discrete in time series.

In the first to the eighth sub-frame processing (Sub-Frames #1 to #8), the plurality of first to fourth voltage signals V1 to V4 related to a plurality of charge acquisition timings are applied a plurality of times to one end of each of the first to the eighth memory cells MC1 to MC8 in the first to the fourth memory arrays MH1 to MH4. The application of the first to the fourth voltage signals V1 to V4 is performed in a time division manner in the first to the eighth storage periods different for each of the first to the eighth memory cells MC1 to MC8.

Thus, in the first to the fourth memory arrays MH1 to MH4, the first to the fourth voltage signals V1 to V4 are applied to the first memory cell MC1 only in the first storage period, the first to the fourth voltage signals V1 to V4 are applied to the second memory cell MC2 only in the second storage period different from the first storage period, the first to the fourth voltage signals V1 to V4 are applied to the third memory cell MC3 only in the third storage period different from the first and the second storage periods, and the first to fourth voltage signals V1 to V4 are applied to the fourth memory cell MC4 only in the fourth storage period different from the first to the third storage periods.

In addition, in the first to the fourth memory arrays MH1 to MH4, the first to the fourth voltage signals V1 to V4 are applied to the fifth memory cell MC5 only in the fifth storage period different from the first to the fourth storage periods, the first to the fourth voltage signals VI to V4 are applied to the sixth memory cell MC6 only in the sixth storage period different from the first to the fifth storage periods, the first to fourth voltage signals V1 to V4 are applied to the seventh memory cell MC7 only in the seventh storage period different from the first to the sixth storage periods, and the first to the fourth voltage signals V1 to V4 are applied to the eighth memory cell MC8 only in the eighth storage period different from the first to the seventh storage periods.

As a result, the first to eighth memory cells MC1 to MC8 in the first to fourth memory arrays MH1 to MH4 integrally store a plurality of first to the eighth detected voltages V11a to V18a, V21a to V28a, V31a to V38a, and V41a to V48a related to a plurality of charge acquisition timings, in a time division manner with the first to the eighth storage periods.

Specifically, the first to the eighth memory cells MC1 to MC8 do not store the first to the eighth detected voltages V11a to V18a, V21a to V28a, V31a to V38a, and V41a to V48a based on a single light source pulsed light LED_{HP} , that is, on a single charge acquisition timing, but integrally store the first to the eighth detected voltages V11a to V18a, V21a to V28a, V31a to V38a, and V41a to V48a related to a plurality of charge acquisition timings.

Next, the output operation of the image sensor A will be described with reference to the timing charts in FIGS. 6A and 6B. FIG. 6A illustrates the output operation under the High Precision (HP) mode, and FIG. 6B illustrates the output operation under the High Speed (HS) mode.

In the output operation under the HP mode, as indicated by the memory reset pulse φMR and the cell selection pulses φMS1 to φMS8 in FIG. 6A, the first to the eighth memory cells MC1 to MC8 in the first to the fourth memory arrays MH1 to MH4 are simultaneously connected to the pixel output unit OUT, with the output timing being different from each other among the first to the fourth memory arrays MH1 to MH4.

Thus, under the HP mode, in the first to the fourth memory arrays MH1 to MH4, the first to the eighth detected voltages V11a to V18a, V21a to V28a, V31a to V38a, and V41a to V48a are simultaneously read and subjected to averaging processing. Then, first to fourth averaged detected voltages V1b to V4b obtained by the averaging processing are input to the pixel output unit OUT and are output to the column signal line (vertical signal line).

According to the HP mode, the first to the fourth averaged detected voltages V1b to V4b obtained by averaging the first to the eighth detected voltages V11a to V18a, V21a to V28a, V31a to V38a, and V41a to V48a serve as the output signals for each pixel G. Thus, it is possible to reduce the depth noise as compared with the case where the first to the eighth detected voltages V11a to V18a, V21a to V28a, V31a to V38a, and V41a to V48a individually serve as the output signal for each pixel G.

In the output operation under the HS mode, as indicated by the memory reset pulse φMR and the cell selection pulses φMS1 to φMS8 in FIG. 6B, the first to the eighth memory cells MC1 to MC8 in the first to the fourth memory arrays MH1 to MH4 are individually connected to the pixel output unit OUT at different timings, in addition to the output timing being different from each other among the first to the fourth memory arrays MH1 to MH4.

Thus, under the HS mode, the averaging processing as under the HP mode is not executed on the first to the eighth detected voltages V11a to V18a, V21a to V28a, V31a to V38a, and V41a to V48a. Still, under the HS mode, all of the first to the eighth memory cells MC1 to MC8 can read the first to the eighth detected voltages V11a to V18a, V21a to V28a, V31a to V38a, and V41a to V48a and output the read voltages to the column signal line (vertical signal line).

Thus, with the HS mode, the depth noise is higher than that under the HP mode, but the effective frame cycle can be set to the sub-frame cycle, and the effective frame rate can be made much higher than that under the HP mode.

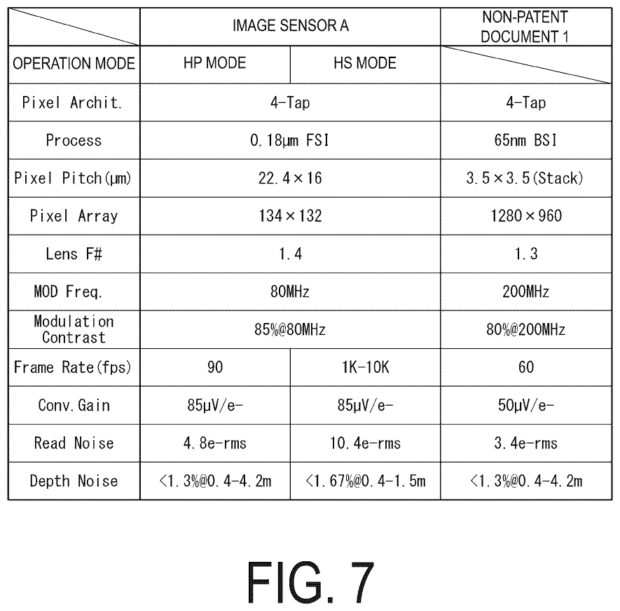

FIG. 7 is a characteristic table illustrating the performance of the image sensor A according to the first embodiment. As illustrated in FIG. 7, the depth noise of the image sensor A under the HP mode is 1.3% in the detection distance range of 0.4 to 4.2 m. The frame rate of the image sensor A under the HP mode is 90 (fps).

The depth noise of the image sensor A under the HS mode is 1.67% in the detection distance range of 0.4 to 1.5 m. The frame rate of the image sensor A under the HS mode is 1 to 10 (kfps). On the other hand, according to Non-Patent Document 1 provided as a reference example, the depth noise is 1.52% in the detection distance range of 0.4 to 4.2 m, and the frame rate is 60 (fps).

Thus, in the image sensor A under the HP mode, the depth noise is lower than that in the operation using one sub-frame as in Non-Patent Document 1, and the frame rate is higher than that in the operation using one sub-frame as in Non-Patent Document 1. In the image sensor A under the HS mode, the depth noise is about the same as that in the case of the operation using one sub-frame as in Non-Patent Document 1, but the frame rate is much higher than that in Non-Patent Document 1.

Therefore, according to the first embodiment, it is possible to provide the image sensor A and the method for driving the same with which the depth noise is suppressed under the HP mode compared with the known technique. According to the second embodiment, it is possible to provide the image sensor A and the method for driving the same with which the depth noise is suppressed under the HS mode and the frame rate is significantly high compared with the known technique.

Now an additional description will be given on the HS mode according to the first embodiment.

As described above, each pixel G in the first embodiment includes the four voltage signal generation units PH1 to PH4 and the four memory arrays MH1 to MH4. Under the HS mode, based on the four modulation pulses φTG1 to φTG4 all of which are set to different charge acquisition timings as described above, the four voltage signal generation units PH1 to PH4 acquire the photocharges of the charge transport photodiode PD.

Meanwhile, under the HS mode, the first modulation pulse φTG1 and the third modulation pulse φTG3 are set to the same charge acquisition timing, whereas the second modulation pulse φTG2 and the fourth modulation pulse φTG4 are set to the same charge acquisition timing.

Under the HS mode, among the four memory arrays MH1 to MH4, the first memory array MH1 acquires the first half of the first voltage signal V1 output from the first voltage signal generation unit PH1, and the second memory array MH2 acquires the second half of the second voltage signal V2 output from the second voltage signal generation unit PH2.

The first to eighth memory cells MC1 to MC8 in the first memory array MH1 respectively integrally store the plurality of first to eighth detected voltages V11′ to V18′ related to the first half of the plurality of first voltage signals V1 in a time division manner with the first to eighth storage periods based on the first half of the plurality of first voltage signals V1 related to the plurality of charge acquisition timings.

The first to the eighth memory cells MC1 to MC8 in the second memory array MH2 respectively integrally store the plurality of first to eighth detected voltages V11″ to V18″ related to the second half of the plurality of second voltage signals V2 in a time division manner with the first to eighth storage periods based on the second half of the plurality of second voltage signals V2 related to the plurality of charge acquisition timings.

Under the HS mode, among the four memory arrays MH1 to MH4, the third memory array MH3 acquires the first half of the third voltage signal V3 output from the third voltage signal generation unit PH3, and the fourth memory array MH4 acquires the second half of the fourth voltage signal V4 output from the fourth voltage signal generation unit PH4.

The first to the eighth memory cells MC1 to MC8 in the third memory array MH3 respectively integrally store the plurality of first to eighth detected voltages V31′ to V38′ related to the first half of the plurality of third voltage signals V3 in a time division manner with the first to eighth storage periods based on the first half of the plurality of third voltage signals V3 related to the plurality of charge acquisition timings.

The first to the eighth memory cells MC1 to MC8 in the fourth memory array MH4 respectively integrally store the plurality of first to eighth detected voltages V31″ to V38″ related to the second half of the plurality of fourth voltage signals V4 in a time division manner with the first to eighth storage periods based on the second half of the plurality of fourth voltage signals V4 related to the plurality of charge acquisition timings.

As described above, under the HS mode, the first memory array MH1 integrally stores the first to the eighth detected voltages V11′ to V18′ related to the first half of the plurality of first voltage signals V1, the second memory array MH2 integrally stores the first to the eighth detected voltages V11″ to V18″ related to the second half of the plurality of second voltage signals V2, the third memory array MH3 integrally stores the first to the eighth detected voltages V31′ to V38′ related to the first half of the plurality of third voltage signals V3, and the fourth memory array MH4 integrally stores the first to the eighth detected voltages V31″ to V38″ related to the second half of the plurality of fourth voltage signals V4.

In effect, under such an HS mode of the first embodiment, an operation of a substantially 2-tap TOF image sensor is performed, instead of the operation of the 4-tap TOF image sensor as under the HP mode.

### Second Embodiment

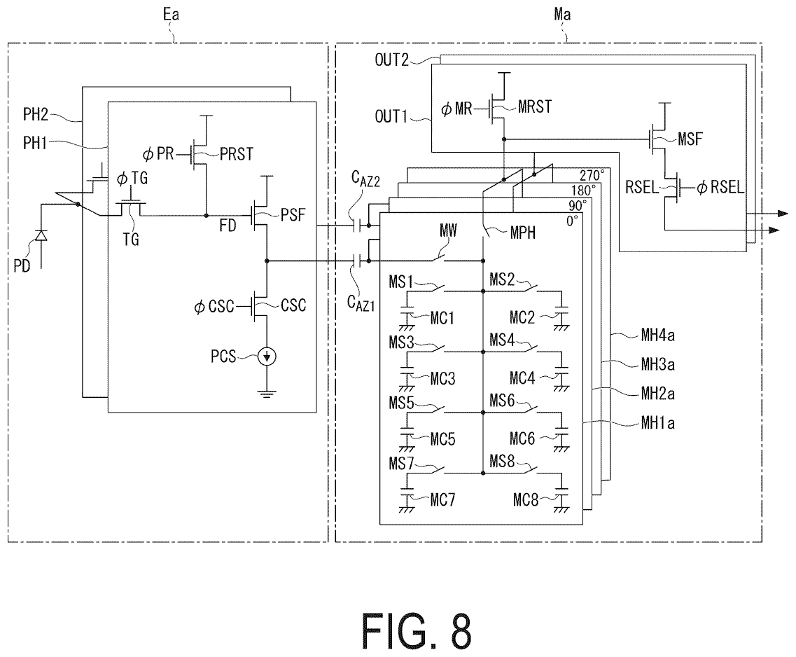

Next, a second embodiment of the present invention will be described with reference to FIG. 8 to FIG. 10.

In FIG. 8, the same functional components as those illustrated in FIG. 1 described above are denoted by the same reference numerals.

As illustrated in FIG. 8, an image sensor B according to the second embodiment includes a pixel Ga including a pixel portion Ea and a pixel memory Ma. The pixel portion Ea in the second embodiment includes the charge transport photodiode PD and two voltage signal generation units PH1 and PH2 (tap circuits). Note that the symbols B and Ga are not illustrated.

The two voltage signal generation units PH1 and PH2 acquire the charge (photocharge) of the charge transport photodiode PD at different timings to generate two voltage signals V1 and V2. Thus, in the image sensor B according to the second embodiment, the modulation time Tp of the two modulation pulses φTG1 and φTG2 corresponds to ½ of the light emission cycle Tc of the light source pulsed light.

The pixel memory Ma according to the second embodiment includes two coupling capacitors C_{AZ1} and C_{AZ2}, four memory arrays MH1a to MH4a, and two pixel output units OUT1 and OUT2. Of the two coupling capacitors C_{AZ1} and C_{AZ2}, the first coupling capacitor C_{AZ1} connects the first voltage signal generation unit PH1 to first and second memory arrays MH1aand MH2a. The second coupling capacitor C_{AZ2} connects the second voltage signal generation unit PH2 to third and fourth memory arrays MH3a and MH4a.

The four memory arrays MH1a to MH4a are obtained by removing the coupling capacitor C_{AZ} from the four memory arrays MH1 to MH4 in the first embodiment as illustrated in the drawing. Specifically, in the pixel memory Ma according to the second embodiment, the first coupling capacitor C_{AZ1} is shared by the first and the second memory arrays MH1a and MH2a, and the second coupling capacitor C_{AZ2} is shared by the third and the fourth memory arrays MH3a and MH4a.

In the image sensor B according to the second embodiment, the first voltage signal V1 is input from the first voltage signal generation unit PH1 to the first and the second memory arrays MH1a and MH2a, and the second voltage signal V2 is input from the second voltage signal generation unit PH2 to the third and the fourth memory arrays MH3a and MH4a.

The four memory arrays MH1a to MH4a acquire the first voltage signal V1 or the second voltage signal V2 corresponding to the four different phase sections in the light emission cycle Tc. The four memory arrays MH1a to MH4a store four detected voltages V1c, V1d, V2c, and V2d related to the four phase sections based on the first voltage signal V1 or the second voltage signal V2 for each phase section.

The first memory array MH1a acquires a part of the first voltage signal V1 corresponding to 0 to 90° of the light emission cycle Tc. The write pulse φMW in the first memory array MH1a is in a high (Hi) state in a period TO corresponding to 0 to 90° of the light emission cycle Tc. Therefore, the write gate MW is set to the closed state in the period T0, acquires the first voltage signal V1c in the period T0, and supplies the signal to one end of each of the eight memory selection gates MS1 to MS8.

Then, the eight memory selection gates MS1 to MS8 in the first memory array MH1a acquire the first voltage signal V1c in the period T0 and sequentially apply the signal to one end of each of the eight memory cells MC1 to MC8. As a result, the eight memory cells MC1 to MC8 store first to eighth detected voltages V11c to V18c based on the first voltage signal V1c in the period T0.

The second memory array MH2a acquires a part of the first voltage signal V1 corresponding to 90 to 180° of the light emission cycle Tc. The write pulse φMW in the second memory array MH2a is in a high (Hi) state in a period T90 corresponding to 90 to 180° of the light emission cycle Tc. Therefore, the write gate MW is set to the closed state in the period T90, acquires the first voltage signal V1d in the period T90, and supplies the signal to one end of each of the eight memory selection gates MS1 to MS8.

Then, the eight memory selection gates MS1 to MS8 in the second memory array MH2a sequentially apply the first voltage signal V1d in the period T90 to one end of each of the eight memory cells MC1 to MC8. As a result, the eight memory cells MC1 to MC8 store first to eighth detected voltages V11d to V18d based on the first voltage signal V1d in the period T90.

The third memory array MH3a acquires a part of the second voltage signal V2 corresponding to 180 to 270° of the light emission cycle Tc. The write pulse φMW in the third memory array MH3a is in a high (Hi) state in a period T180 corresponding to 180 to 270° of the light emission cycle Tc. Therefore, the write gate MW is set to the closed state in the period T180, acquires the second voltage signal V2c in the period T180, and supplies the signal to one end of each of the eight memory selection gates MS1 to MS8.

Then, the eight memory selection gates MS1 to MS8 in the third memory array MH3a sequentially apply the second voltage signal V2c in the period T180 to one end of each of the eight memory cells MC1 to MC8. As a result, the eight memory cells MC1 to MC8 store first to eighth detected voltages V21c to V28c based on the second voltage signal V2c in the period T180.

The fourth memory array MH4a acquires a part of the second voltage signal V2 corresponding to 270 to 360° of the light emission cycle Tc. The write pulse φMW in the fourth memory array MH4a is in a high (Hi) state in a period T270 corresponding to 270 to 360° of the light emission cycle Tc. As a result, the write gate MW is set to the closed state in the period T270, acquires the second voltage signal V2d in the period T270, and supplies the signal to one end of each of the eight memory selection gates MS1 to MS8.

Then, the eight memory selection gates MS1 to MS8 in the fourth memory array MH4a sequentially apply the second voltage signal V2d in the period T270 to one end of each of the eight memory cells MC1 to MC8. As a result, the eight memory cells MC1 to MC8 store first to eighth detected voltages V21d to V28d based on the second voltage signal V2d in the period T270.

Of the two pixel output units OUT1 and OUT2, the first pixel output unit OUT1 has the input end commonly connected to the first and the third memory arrays MH1a and MH3a, reads the first to the eighth detected voltages V11c to V18c and V21c to V28c from the first and the third memory array MH1a and MH3a, and outputs the voltages to the column signal line (vertical signal line).

The second pixel output unit OUT2 has the input end commonly connected to the second and the fourth memory arrays MH2a and MH4a, reads the first to the eighth detected voltages V11d to V18d and V21d to V28d from the second and the fourth memory arrays MH2a and MH4a, and outputs the voltages to the column signal line (vertical signal line).

The image sensor B according to the second embodiment is a 2-tap 4-phase TOF image sensor because the number (tap number) of tap circuits (voltage signal generation units PH1 and PH2) forming the modulation circuit is “2” and the voltage signals V1 and V2 are extracted from the respective tap circuits in four phases. The basic concept of the 2-tap 4-phase TOF image sensor is well known.

Under the HP mode with the modulation frequency set to 25 MHz, the image sensor B according to the second embodiment has the depth noise of 1.27% in a detection distance range 0.6 to 6.0 m, and the frame rate of 60 (fps). Under the Hs mode with the modulation frequency set to 50 MHz, the image sensor B has the depth noise of 1.84% in a detection distance range 0.6 to 3.0 m, and the frame rate of 1 (kfps) or more.

Therefore, according to the second embodiment, it is possible to provide the image sensor B and the method for driving the same with which the depth noise is suppressed under the HP mode compared with the known technique. According to the second embodiment, it is possible to provide the image sensor B and the method for driving the same with which the depth noise is suppressed under the HS mode and the frame rate is significantly high compared with the known technique.

Note that the present invention is not limited to the above-described embodiments, and for example, the following modifications are conceivable.

(1) Although the 4-tap type is employed in the first embodiment, the present invention is not limited to this. In other words, the number of taps of the modulation circuit may be other than four, as long as there are a plurality of taps. In the second embodiment, the 2- tap 4-phase type is employed, but the present invention is not limited to this. In other words, the number of taps of the modulation circuit may be other than two as long as there are a plurality of taps, and the number of phases may be other than four as long as there are a plurality of phases.
(2) In each of the above-described embodiments, the number of memory cells MC1 to MC8, that is, the number of times the sub-frame processing is executed (Sub-Frames), in other words, the number of memory cells MC1 to MC8, and the number of storage periods is eight (Sub-Frames #1 to #8), but the present invention is not limited thereto. In other words, the number of times the sub-frame processing is executed (the number of memory cells) may be other than eight as long as the processing is executed a plurality of times.
(3) In each of the above-described embodiments, the image sensors A and B having the HP mode and the HS mode as the operation mode are described. However, the present invention is not limited to this. One of the HP mode and the HS mode may be provided as the operation mode.
(4) In each of the above-described embodiments, the light source pulsed light with the light emission pulse time interval Tc is used as the light source light, but the present invention is not limited to this. Instead of the light source pulsed light, continuous light whose light amount does not change over time or continuous light whose light amount changes in a predetermined cycle may be used as the light source light.
(5) In each of the above-described embodiments, a Time of Flight (TOF) image sensor is described, but the present invention is not limited to this. That is, the present invention can also be applied to an image sensor of a type in which reflected light of light source light such as light source pulsed light is not used as incident light. For example, the present invention can also be applied to an image sensor of a type in which fluorescence generated from a measurement target object by a light source such as light source pulsed light is used as incident light.

### REFERENCE SIGNS LIST

A, B Image sensor
G, Ga Pixel
E, Ea Pixel portion
PH1 to PH4 Voltage signal generation unit
PD Charge transport photodiode (light reception element)
TG1 Transfer gate transistor
PSF Pixel source follower driver
CSC Pixel source follower drive selection switch
PCS Pixel current source
PRST Pixel reset gate
M, Ma Pixel memory
MH1 to MH4 Mmory array
OUT Pixel output unit
CAZ Coupling capacitor
MW Write gate
MS1 to MS8 Memory selection gate
MC1 to MC8 Memory cell
MPH Read gate
MRST Memory reset gate
MSF Memory source follower driver
RSEL Pixel selection switch
1 LED light emission unit
2 Pixel array
3 Pixel control unit
4A, 4B Clock control unit
5A, 5B Modulation pulse generation unit
6 Global control pulse generation unit
7 Row selection unit
8 Column selection unit
9 Signal reading unit
10 Bias power supply unit
11 Read drive unit
12 Output unit

1. An image sensor, comprising:
a light reception element configured to receive incident light;
a plurality of voltage signal generation circuitries configured to acquire charge of the light reception element at a plurality of charge acquisition timings and convert the charge into a plurality of voltage signals;
a pixel output circuitry configured to output a plurality of detected voltages based on the plurality of voltage signals; and
a plurality of pixel memories configured to integrally store the plurality of detected voltages related to the plurality of charge acquisition timings in a plurality of memory cells, wherein
the pixel output circuitry reads and outputs the detected voltages stored in the plurality of memory cells.

2. The image sensor according to claim 1, wherein the plurality of memory cells correspond to a plurality of storage periods including the plurality of charge acquisition timings, and each integrally store the plurality of detected voltages in a corresponding one of the storage periods.

3. The image sensor according to claim 1, wherein the pixel output circuitry averages and reads the detected voltages stored in the plurality of memory cells.

4. The image sensor according to claim 1, wherein the pixel output circuitry individually reads the detected voltages stored in the plurality of memory cells.

5. The image sensor according to claim 1, wherein each of the plurality of pixel memories acquire the voltage signals corresponding to different phase sections in a cycle of the plurality of charge acquisition timings, and store the detected voltage for each of the phase sections.

6. The image sensor according to claim 3, wherein number of the voltage signal generation circuitries provided is four.

7. The image sensor according to claim 5, wherein number of the voltage signal generation circuitries provided is two, and number of the phase sections is four.

8. The image sensor according to claim 1, wherein the incident light is reflected light of light source pulsed light of a predetermined cycle.

9. A method of driving an image sensor configured to receive incident light by a light reception element, acquire charge of the light reception element at a plurality of charge acquisition timings and convert the charge into a plurality of voltage signals, and output a plurality of detected voltages based on the plurality of voltage signals from a pixel, the method comprising:
integrally storing the plurality of detected voltages related to the plurality of charge acquisition timings in a plurality of memory cells; and
reading and outputting the detected voltages stored in the plurality of memory cells.
